(19) United States
(12) Patent Application Publication
(10) Pub. No.: US 2022/0067203 A1
(43) Pub. Date: Mar. 3, 2022

(54) Machine-learning apparatus and technique

(71) Applicant: Arm Cloud Technology, Inc., San Jose, CA (US)

(72) Inventors: Remy POTTIER, Grenoble (FR); Yves Thomas LAPLANCHE, Valbornne (FR); Daren CROXFORD, Swaffham Prior (GB)

(21) Appl. No.: 17/445,664

(22) Filed: Aug. 23, 2021

(30) Foreign Application Priority Data
Aug. 27, 2020 (GB) 2013479.7

(51) Int. Cl. G06F 21/62; G06F 11/36; G06N 20/00

(52) U.S. Cl. CPC G06F 21/6254; G06F 21/6227; G06N 20/00; G06F 11/3692; G06F 11/3688

(57) ABSTRACT

Provided is a technology including an apparatus in the form of a privacy-aware model-based machine learning engine comprising a dispatcher responsive to receipt of a data request from an open model-based machine learning engine to initiate data capture; a data capture component responsive to the dispatcher to capture data comprising sensitive and non-sensitive data to a first dataset; a sensitive data detector operable to scan the first dataset to detect the sensitive data; a sensitive data obscuration component responsive to the sensitive data detector to create an obscured representation of the sensitive data to be stored with the non-sensitive data in a second dataset; and a delivery component operable to deliver the second dataset to the open model-based machine learning engine.

### CROSS-REFERENCE TO RELATED APPLICATIONS

This application claims priority pursuant to 35 U.S.C. 119(a) to United Kingdom Patent Application No. 2013479.7, filed Aug. 27, 2020, which application is incorporated herein by reference in its entirety.

### BACKGROUND

The present technology is directed to an apparatus and technique to enable a model-based machine learning engine to maintain privacy of sensitive data. The model-based machine learning engine may be provided in the form of dedicated hardware or in the form of firmware or software, typically at a low level in the system stack (or of a combination of hardware and low-level code), to address the difficulties of combining accuracy of learning with secure handling of sensitive information.

Model-based machine learning engines typically take the form of artificial intelligence reasoning systems wherein data is captured, analysed in accordance with learned patterns of discrimination and reasoning, and an outcome is determined—typically in the form of a final output, or in the form of a request for further information to be input, with a view to enabling a final outcome.

In a first approach to addressing the difficulties of combining accuracy of learning with secure handling of sensitive information there is provided a technology including an apparatus in the form of an apparatus in the form of a privacy-aware model-based machine learning engine comprising a dispatcher responsive to receipt of a data request from an open model-based machine learning engine to initiate data capture; a data capture component responsive to the dispatcher to capture data comprising sensitive and non-sensitive data to a first dataset; a sensitive data detector operable to scan the first dataset to detect the sensitive data; a sensitive data obscuration component responsive to the sensitive data detector to create an obscured representation of the sensitive data to be stored with the non-sensitive data in a second dataset; and a delivery component operable to deliver the second dataset to the open model-based machine learning engine.

In a second approach there is provided a method of operating a privacy-aware model-based machine learning engine operable in communication with an open engine.

In a hardware implementation, there may be provided electronic apparatus comprising logic elements operable to implement the methods of the present technology. In another approach, the method may be realised in the form of a computer program operable to cause a computer system to function as a privacy-aware model-based machine learning engine according to the present technology.

### BRIEF DESCRIPTION OF THE DRAWINGS

Implementations of the disclosed technology will now be described, by way of example only, with reference to the accompanying drawings, in which:

FIG. 1 shows a simplified example of a system comprising a model-based machine learning engine operable according to an embodiment of the present technology that may comprise hardware, firmware, software or hybrid components; and

FIG. 2 shows one example of a method of operation of a model-based machine learning engine according to an instance of the present technology.

### DETAILED DESCRIPTION

A system constructed according to an implementation of the present technology, for example, as a neural network, will typically operate in two phases. The first phase is the training phase: the neural network is trained—this involves providing new stimuli to the network to update the network. The second phase is the inferencing phase: the network is executed on stimuli to generate outputs. In one example, a neural network is executed to analyse an image to provide an output according to the earlier training it has received. Typically, the inferencing phase will be run much more frequently than the training phase.

In general terms, a system constructed using the apparatus of the present technology comprises two zones: a private zone and a public zone. The private zone may take the form of a privacy-aware, or privacy-respecting, engine. The private zone can be a secure enclave (one that offers an intruder a limited attack surface) in a device such as an IoT device. An application agent operating as, or on behalf of, a consuming application and running in a public zone sends a model specification and a cooperation request to a dispatcher agent running in the private zone. One possible example of a cooperation request comprises an application description (for example airport security baggage tracking) and a list of attributes it wants to predict (for example, the relationship between an item of baggage and an owner in an airport scene—the application can operate without needing to have awareness of private attributes, such as the image of the owner's face).

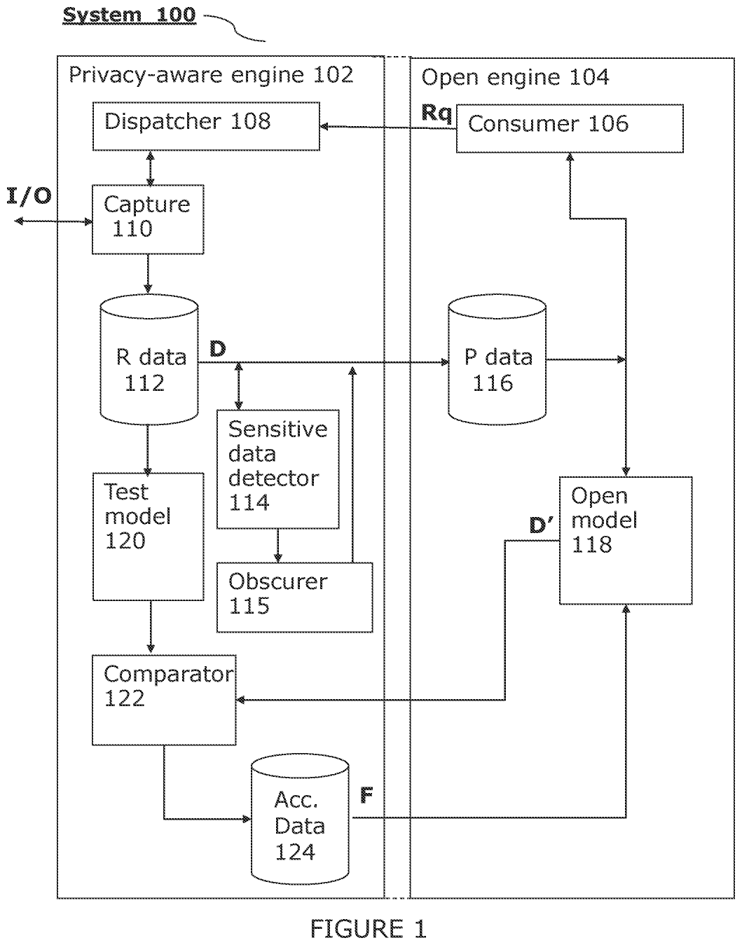

In FIG. 1, there is shown a system 100 comprising a privacy-aware, model-based machine learning engine 102 operable according to an embodiment of the present technology. Engine 102 comprises a dispatcher agent 108 operable in response to a request (shown in the figure as the path marked Rq) from open engine 104 to initiate operation of a capture component 110 to capture data over an I/O interface. Capture component 110 captures data across some form of I/O interface and thereby creates a raw dataset R data 112, which may contain private or sensitive information that must not be allowed out beyond the boundary of the privacy-aware engine 102. Before the dataset or data stream from R data 112 can pass over the boundary, it must be examined by sensitive data detector 114. Sensitive data detector 114 is operable to detect private or sensitive data according to supplied criteria—in some cases, the criteria are pre-set; in other cases, the criteria may be supplied with request Rq from open engine 104 according to parameters supplied by consumer application 106. Responsive to detection of private or sensitive data in R data by sensitive data detector 114, obscurer 115 is operable to apply some means of obscuration to the data—for example, the data may be obscured using noise applied to the signal, or some means of encryption or other obfuscation may be used to hide or blur the data before the dataset P data 116 comprising the non-sensitive data and the obscured private or sensitive data traverses delivery path D from privacy-aware engine 102 to open engine 104. Dataset P data 116 is used by consumer application 106 to create open model 118.

In one variant, Dataset P may contain the non-sensitive data and a position and length indication of the obscured sensitive data, rather than the obscured image of the data. This would have the effect of reducing the chances that the open engine 104 will derive incorrect inferences from the obscured image and would save processing time and resource at open engine 104. The variant Dataset P would also require less bandwidth to pass from privacy-aware engine 102 to open engine 104.

Open model 118 is then used by consumer 106 to perform reasoning expressed as outcomes that are intended to represent as closely as possible ground truth—that is, truth to the real world, as opposed to mere logical consistency with a model. The accuracy of the outcomes of a model is clearly of importance, not merely in determining the utility of the model at a point in time, but also as an indicator of the need for refinement of the model. To this end, privacy aware engine 102 is provided with means to create a test model 120 using the same specification parameters as those used for the open model 118 in open engine 104. Privacy-aware engine 102 operates test model 120 that was created using the raw data from R data 112 to perform reasoning in parallel to the reasoning performed using open model 118 in open engine 104 and based on the same inputs that were used to elicit outcomes from open model 118. A comparator 122 is operable to access the outcomes from test model 120 and open model 118, perform comparisons and produce accuracy data 124. Comparator 122 has access to open model 118 (which contains, by definition, no unobscured private data) and to test model 120, which is derived from R data 112 and which therefore comprises both non-sensitive data and unobscured private data. Comparator 122 is thus confined to privacy-aware-engine 102, and is restricted as to its output to open engine 104 (or any other external entity). So, although the test model has basis in R data, the comparator 122 accesses the model's outcomes and compares them with those of the open model—thus the derived accuracy data 124 does not contain any sensitive data, and can accordingly be shared with open engine 104 using feedback path F, so that consumer application 106 can invoke open model 118 to refine its reasoning over P data, and thus improve its approach to providing outcomes based on ground truth.

According to the present technique, any private or sensitive data in a dataset are identified by the application of appropriate pattern recognition or other means. Once the private or sensitive data are identified, random noise, encryption or any other form of obfuscation is applied by a privacy aware engine by a privacy-respecting machine-learning model (the P model) applied to the raw dataset (the R dataset). This can be done directly in the device that controls data capture, or at the input of the model that needs to be trained, thus creating a privacy-aware dataset (the P dataset). The consumer (for example, a business application that requires a trained ML model is then provided with access to an open model (one that contains no route by which private or sensitive data can be determined) that has been trained using the P dataset. This training can be done in the same device, in the cloud, in a gateway or in another (peer or server) device. Robustness of the model is key here: inferencing over the open model derived from the privacy-respecting P dataset must still deliver as good a result as inferencing on a test model derived from the R dataset. Measuring the exact delta of utility loss due to the privacy-respecting obscuration process applied on the raw data is possible using the feedback mechanism described with reference to FIG. 1 above. Because the open model derived from the privacy-respecting P dataset never sees the raw private or sensitive R data, no model inversion attack, membership inversion attack, or reconstruction attacks are possible.

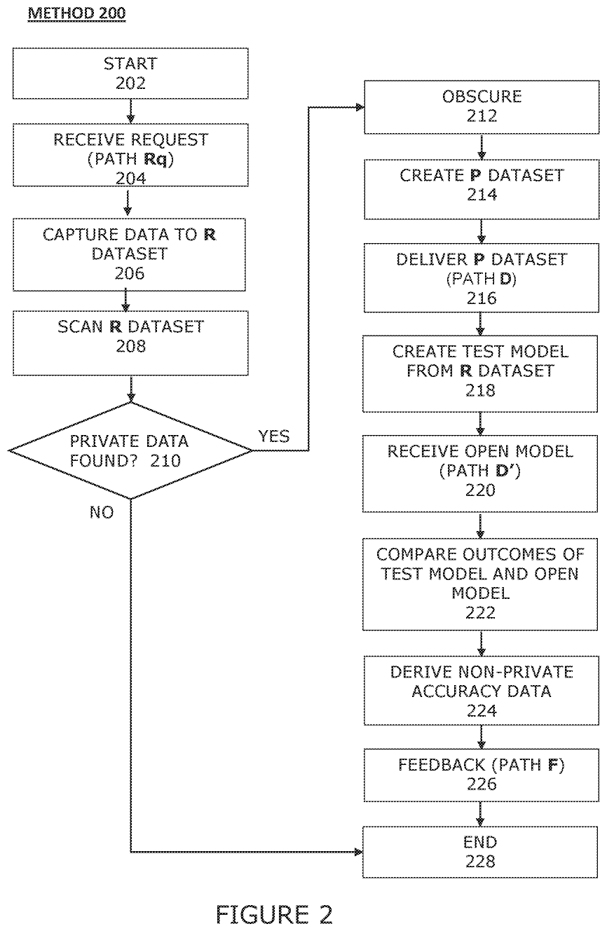

The method of operation 200 of a privacy-aware engine 102 according to the present technology is shown in FIG. 2, beginning at START 202. At 204 a request for cooperation is received over path Rq, and at 206 a data capture component 110 is invoked to capture data over an I/O channel to create the R dataset, which contains both non-sensitive and potentially sensitive or private data. The R dataset is scanned at 208 (by the sensitive data detector 114 of FIG. 1) to detect private or sensitive data. If no such private or sensitive data is found at test step 210, the method 200 completes at END 228. If private or sensitive data is detected at test step 210, obscurer 115 of FIG. 1 is invoked at 212 to obscure the data (by any of the available means of obscuration—for example, by adding noise or by encrypting the data) to create the P dataset at 214. The P dataset thus contains non-sensitive data in clear along with any private or sensitive data in its obscured form. The P dataset is thus suitable for passing out of the privacy-aware engine to an external entity that is not to have unobscured access to private or sensitive data. At 216, the P dataset is delivered over path D to the open engine 104 of FIG. 1, where it can be used to execute the open model 118 of FIG. 1, such that reasoning can be performed over the P data on behalf of the consumer application 106 of FIG. 1. From time to time, at 218 a test model may be executed using the R dataset. The test model of 218 is not suitable for delivery outside the privacy-aware engine 102, as that would potentially expose the private or sensitive data from which it has been created. The test model of 218 is therefore only used within the privacy-aware engine 102, as will now be described. At 220 the open model may be received by privacy-aware engine 102 over path D′ from open engine 104. The open model may then be executed in the privacy-aware engine to provide outputs for comparison purposes. In one variant, only outcomes derived from execution of open model 118 in open engine 104 may be delivered at 220 to comparator 122. At 222 the outcomes of the test model and the open model for the same inputs are compared and at 224 non-private accuracy data is derived from the comparison of 222. The non-private accuracy data of 224 is delivered from privacy-aware engine 102 over feedback path F to open engine 104, thus making it available for open engine 104 to refine its open model 118. The method 200 then completes one iteration at END 228. As will be clear to one of ordinary skill in the art, further iterations of all or part of the method are possible after END 228. For example, as additional data is captured, the steps from 206 to END 228 may be repeated to enable progressive refinement of the open model 118 over time. Similarly, from time to time when retraining of the model is needed, the steps from 218 to 228 may be performed.

As shown in the worked examples of FIGS. 1 and 2, machine intelligence is applied in three ways in the present technology. First, a machine learning privacy-respecting model that is trained to recognise privacy related data inputs, ideally running in the device that controls data capture in a secure enclave, automatically hides any private or sensitive data. Second, a machine learning “open” model is used by the consuming application—the model has some robustness built into its reasoning to enable it to perform correct inferencing (and so be able to be trained), and then deliver the expected inference (ground truth or an approximation thereto) even when the input data are partially blurred. It is envisaged that the loss function (caused by the obscuration of the private data) can be evaluated and at least partially compensated for, so that ongoing retraining can refine the model to improve inferencing over the partially-obscured dataset. Third, a test model function provides a means of evaluating the performance of the open model 118 against that of a test model 120 to determine whether changes are required, either to the training of the open and test models, or to the way in which the sensitive data is obscured.

The present technology can be applied to data derived from image recognition, sensor-related data or any other dataset (for example, medical records, customer data in a business setting, etc.) The machine learning techniques may include artificial neural networks, for example, convolutional neural networks (CNN), such as deep convolutional nets, which may suitably be deployed to handle non-linear data, such as static image data, or it may include recurrent neural networks (RNN) deployed to handle linear sequential data, such as speech and text.

Taking the example of image data (although other data sources are also applicable), for supervised training, labelled stimuli are created to indicate what portions of an image are considered to be sensitive, and what data in the image is considered to be non-sensitive. For example, faces, license plates, or credit card numbers might all be considered to be sensitive information, while general scene details would be considered non-sensitive. The stimuli are used to train a neural network to create a neural network that detects sensitive portions of the image and distinguishes them from non-sensitive background. The neural network functions as sensitive data detector 114″.

For image data an image segmentation convolutional neural network (CNN) is applied to an image that may contain sensitive data, to detect the sensitive data and also indicate where that data is located. For the sake of preserving privacy, it may be preferable not to use any image recognition system that preserves detailed outlines of objects, but rather to use a system that operates using bounding boxes or the like. There are two possible approaches:
Object detection—Generates bounding boxes of the sensitive data. This will provide additional privacy—as the outline of an object could be used to determine what the object is, while a bounding box does not give this information. Examples of CNN include:
   R-CNN (Regions with CNN), Fast R-CNN, Faster R-CNN
Instance segmentation—Pixel level segmentation
   Mask R-CNN.

As will be clear to one of ordinary skill in the art, the neural network architecture chosen will depend upon the type of data being used. Thus, in another example, audio data such as speech processing data will likely use Long Short-term Memory RNN (Recurrent Neural

Network) type architectures.

Importantly, private data never leave the original device that is responsible for the capture of the data, and are never seen in their raw format by the production “open” model, since the model is trained using a dataset that has already had all private or sensitive data obscured.

In one further refinement, the training scope could be further limited by restricting, at the source of the data, what can and cannot be with the data. For example, location data may be labelled with a “location” tag, and a consumer application requesting location information may have its access restricted to information or insights derived purely from data that is labelled with the “location” tag.

The present technology thus provides an infrastructure for machine learning (ML) model training and inferencing on a dataset in which the privacy-related data have been obscured (for example by masking the data using noise or by encrypting the data) in the device that is responsible for controlling the capture of the data, and providing only a redacted dataset to be modelled and used by the consuming application. This enables ML training and inferencing with privacy as a default.

In one possible scenario, where captured data comprises image data, an image with “blurred” portions (e.g. hidden license plate, human faces etc, . . . ) can be used to train the model. The model can then be used for inferencing that a car is entering a parking lot such that an alert is required (the car was travelling too fast; vehicles of that size or type are not authorized to enter, or the like. Similarly, an image having a blurred face part shows that a person entered an airport carrying a blue bag, but gave this bag to someone else, who subsequently entered a restricted area (indicating a possible risk of smuggling or a security cordon breach). The model-based learning engine can thus provide the infrastructure to that makes the reasoning and outcomes of AI possible without access to any sensitive information, such as the vehicle's license plate, or the face of the person entering the airport. In this way, the goal of enabling successful ongoing model training and refinement, while preserving the privacy of personal or otherwise sensitive data, is achieved.

The consumer application is operable to perform inferencing from data to produce an outcome—to do this, it must be able to express what type of data is needed to perform its task, to construct and send appropriate cooperation requests to at least one data provider in the form of a privacy-aware engine, and subsequently to receive data for use in modelling and inferencing.

A dispatcher agent running in a secure zone receives the cooperation request, and needs to be operable to create a data capture and handling task and invoke the data capture component to create a raw dataset based on cooperation request. The dispatcher agent must be further operable to define private or sensitive data attributes that should be obscured in the dataset (or data stream) and to send requests to a sensitive data detector component and obscurer to process the data before it is returned to the consumer in the open engine.

The privacy-aware engine, preferably running in a secure zone, receives the cooperation request at its dispatcher component, and includes components operable to identify in the dataset or data stream the private or sensitive information (for example, detecting and marking human faces in an image stream), and to determine which data should be permitted to pass “in clear” and which should be obscured by an obscuration component. The sensitive data detector in the privacy-aware engine sends a cooperation request to the obscurer, for example in the form of a Clear list and an Obscure list. For example, the Obscure list may include column and line references for private or sensitive data in a dataset, or it may specify areas in a picture that may contain private or sensitive data that should be obscured. The action of the obscurer creates a modified dataset or data stream with any private data obscured. The raw dataset may be transformed into a privacy-respecting dataset by running, for example, a privacy-preserving Generative Adversarial Network (GAN) in conjunction with a differential privacy technique. Differential privacy can be implemented in a GAN by adding noise to the gradient during the model learning procedure. The two ecosystems of the data-providing privacy-aware engine and the data-consuming open engine are thus operable to cooperate, with data privacy preservation guaranteed by the design of the systems. In one variant, as described above, the open engine may be provided with the non-sensitive data and a position and length indication of the obscured sensitive data, rather than the obscured image of the data. This would have the effect of reducing the chances that the open engine will derive incorrect inferences from the obscured image and would save processing time and resource at open engine. The variant dataset would also require less bandwidth to pass from privacy-aware engine to open engine 104.

By operating the apparatus or applying the technique of the present technology, the “open engine” device that hosts the consumer application cannot leak any private data, but the dataset or data stream can still be used for model training (and inference) to perform the consumer application. None of the known ML model attacks (model inversion, reconstruction or membership inference) can break the privacy.

Measuring the “utility Loss” caused by the application of the privacy preserving technique of the present technology applied can be achieved by training the application model as a test model on the raw data in the privacy-aware engine and in parallel in the open engine using the privacy-aware dataset. A comparison on a specified volume of test data could be performed to provide a ratio or percentage representation of accuracy loss due to the privacy-preserving steps. The robustness of the model trained on the privacy-aware dataset (thus with a certain quantity of obscured data) can then be measured.

As will be appreciated by one skilled in the art, the present techniques may be implemented such that the privacy-aware engine and the open engine are on the same processing system or device, or they may be on different devices. For example, a privacy-aware engine may be implemented on a local device, such as an IoT sensor device, for example, while the open engine is implemented in the cloud or on a central server.

In an example, there may be provided a privacy-aware model-based machine learning engine comprising: dispatcher logic responsive to receipt of a data request from an open model-based machine learning engine to initiate data capture; data capture logic responsive to the dispatcher logic to capture data comprising sensitive and non-sensitive data to a first dataset; sensitive data detector logic operable to scan the first dataset to detect the sensitive data; sensitive data obscuration logic responsive to the sensitive data detector logic to create an obscured representation of the sensitive data to be stored with the non-sensitive data in a second dataset; and delivery logic operable to deliver the second dataset to the open model-based machine learning engine. The privacy-aware model-based machine learning engine may comprise test model logic operable to perform machine learning using the first dataset as input. The privacy-aware model-based machine learning engine may further comprise comparator logic operable to accept as inputs at least one outcome of the test model logic and an outcome of a model derived by machine learning from the second dataset. The comparator logic may be used to produce non-sensitive accuracy data. The comparator logic may be used to deliver the non-sensitive accuracy data to the open model-based machine learning engine. The privacy-aware model-based machine learning engine may be operable in response to detection of inaccuracy to initiate retraining of at least one of the sensitive data detector logic or the sensitive data obscuration logic. The privacy-aware model-based machine learning engine may also be operable in response to detection of inaccuracy to initiate retraining of the model-based machine learning engine.

In a further example, there may be provided a method of operating a privacy-aware model-based machine learning engine comprising: receiving a data request from an open model-based machine learning engine to initiate data capture; responsive to receiving the data request, capturing data comprising sensitive and non-sensitive data to a first dataset; scanning the first dataset to detect the sensitive data; responsive to detecting the sensitive data, creating an obscured representation of the sensitive data to be stored with the non-sensitive data in a second dataset; and delivering the second dataset to the open model-based machine learning engine.

The method may further comprise performing machine learning using the first dataset as input to a test model to derive a test model outcome. The method may further comprise operating comparator logic to accept as inputs at least one the test model outcome and an outcome of a model derived by machine learning from the second dataset. The comparator logic may be used to produce non-sensitive accuracy data. The comparator logic may also be used to deliver the non-sensitive accuracy data to the open model-based machine learning engine.

As will be appreciated by one skilled in the art, the present techniques may be embodied as a system, method or computer program product. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments. In particular, in hardware embodiments, the term “component” may be interchangeable with the term “logic” and may refer to electronic logic structures that implement functions according to the described technology.

Furthermore, the present technique may take the form of a computer program product tangibly embodied in a non-transitory computer readable medium having computer readable program code embodied thereon. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C++, a scripting language, such as Python, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language). Program code for carrying out operations of the present techniques may also use library functions from a machine-learning library, such as TensorFlow.

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction-set to high-level compiled or interpreted language constructs.

It will also be clear to one of skill in the art that all or part of a logical method according to embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a hardware descriptor language (such as Verilog™ or VHDL) which may be stored using fixed carrier media.

In one alternative, an embodiment of the present techniques may be realized in the form of a computer implemented method of deploying a service comprising steps of deploying computer program code operable to, when deployed into a computer infrastructure or network and executed thereon, cause the computer system or network to perform all the steps of the method.

In a further alternative, an embodiment of the present technique may be realized in the form of a data carrier having functional data thereon, the functional data comprising functional computer data structures to, when loaded into a computer system or network and operated upon thereby, enable the computer system to perform all the steps of the method.

It will be clear to one skilled in the art that many improvements and modifications can be made to the foregoing exemplary embodiments without departing from the scope of the present disclosure.

1. A privacy-aware model-based machine learning engine comprising:
a dispatcher component responsive to receipt of a data request from an open model-based machine learning engine to initiate data capture;
a data capture component responsive to the dispatcher component to capture data comprising sensitive and non-sensitive data to a first dataset;
a sensitive data detector component operable to scan the first dataset to detect the sensitive data;
a sensitive data obscuration component responsive to the sensitive data detector component to create an obscured representation of the sensitive data to be stored with the non-sensitive data in a second dataset; and
a delivery component operable to deliver the second dataset to the open model-based machine learning engine.

2. The privacy-aware model-based machine learning engine of claim 1, further comprising a test model component operable to perform machine learning using the first dataset as input.

3. The privacy-aware model-based machine learning engine of claim 2, further comprising a comparator component operable to accept as inputs at least one outcome of the test model component and an outcome of a model derived by machine learning from the second dataset.

4. The privacy-aware model-based machine learning engine of claim 3, the comparator component further operable to produce non-sensitive accuracy data.

5. The privacy-aware model-based machine learning engine of claim 4, the comparator component further operable to deliver the non-sensitive accuracy data to the open model-based machine learning engine.

6. The privacy-aware model-based machine learning engine of claim 5, operable in response to detection of inaccuracy to initiate retraining of at least one of said sensitive data detector component or said sensitive data obscuration component.

7. The privacy-aware model-based machine learning engine of claim 5, operable in response to detection of inaccuracy to initiate retraining of said model-based machine learning engine.

8. A method of operating a privacy-aware model-based machine learning engine comprising:
receiving a data request from an open model-based machine learning engine to initiate data capture;
responsive to receiving the data request, capturing data comprising sensitive and non-sensitive data to a first dataset;
scanning the first dataset to detect the sensitive data;
responsive to detecting the sensitive data, creating an obscured representation of the sensitive data to be stored with the non-sensitive data in a second dataset; and
delivering the second dataset to the open model-based machine learning engine.

9. The method of claim 8, further comprising performing machine learning using the first dataset as input to a test model to derive a test model outcome.

10. The method of claim 9, further comprising operating a comparator component to accept as inputs at least one said test model outcome and an outcome of a model derived by machine learning from the second dataset.

11. The method of claim 10, further comprising operating the comparator component to produce non-sensitive accuracy data.

12. The method of claim 11, further comprising operating the comparator component to deliver the non-sensitive accuracy data to the open model-based machine learning engine.

13. A computer program product stored on a non-transitory computer-readable medium and comprising computer program code to, when loaded into a computer system and executed thereon, cause the computer system to:
receive a data request from an open model-based machine learning engine to initiate data capture;
responsive to receiving the data request, capture data comprising sensitive and non-sensitive data to a first dataset;
scan the first dataset to detect the sensitive data;
responsive to detecting the sensitive data, create an obscured representation of the sensitive data to be stored with the non-sensitive data in a second dataset; and
deliver the second dataset to the open model-based machine learning engine.
